(19) United States
(12) Patent Application Publication
(10) Pub. No.: US 2009/0249678 A1
(43) Pub. Date: Oct. 8, 2009

(54) Decoy structure

(76) Inventor: Joseph S. Arnold, Wind Gap, PA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/382,289

(22) Filed: Mar. 12, 2009

Related U.S. Application Data
(60) Provisional application No. 61/064,978, filed on Apr. 7, 2008.

(51) Int. Cl. A01M 31/06

(52) U.S. Cl. 43/2

(57) ABSTRACT

The decoy structure is formed of a central upper spine and lateral ribs, with a support rod resiliently attached to the approximate midpoint of the spine. The lower end of the support rod has a weighted base. A removable flexible cover is patterned to resemble the object game, and is open at the bottom. This allows the ribs to be curled inwardly toward one another with their distal ends and lower portions of the cover overlapping to reduce the structure diameter for compact storage. The support rod swings rearwardly through the open bottom of the structure, allowing the decoy to be stored in a small diameter tube. The decoy is quickly deployed by withdrawing it from its tube and tossing it to the desired location. The weighted base deploys downwardly, with aerodynamic drag holding the body above the base as it lands to orient the decoy properly in the field.

### CROSS-REFERENCE TO RELATED APPLICATION

This application claims the benefit of U.S. Provisional Patent Application Ser. No. 61/064978, filed Apr. 7, 2008.

### BACKGROUND OF THE INVENTION

1. Field of the Invention

The present invention relates generally to hunting paraphernalia, and more particularly to a decoy structure having a spine and a series of lateral ribs formed of wire or other thin, resilient material and having a lightweight cover removably installed thereon. A weighted base is also provided.

2. Description of the Related Art

Decoys have long been used in hunting to attract game. Most such decoys are formed of solid and relatively dense material, or at least have a relatively hard and dense shell. Most such decoys must be placed specifically by the hunter; they are sufficiently massive that they cannot be tossed more than several feet to a location beyond that of the concealed hunter. This is even more true of decoys having special bases, spikes, etc., which must be driven or implanted into the ground. Obviously, such decoys cannot be tossed into position at all. This is particularly critical when a hunter is in a blind, and wishes to distance himself from his prey to avoid their detecting his scent or hearing some slight sound he might produce. In addition to the above consideration, most such heavier decoys have sufficient upper mass that they will generally tip over if tossed randomly into the field. This is true even of flotation type decoys (ducks and geese, etc.). Such flotation decoys will generally promptly right themselves when tossed into the water, but will often remain tipped over on dry land if they end up in such a tipped position when tossed.

The present inventor is aware of a number of decoys having one or more stakes depending therefrom. The stake is driven into the ground to deploy the decoy. This is particularly common with turkey decoys, since such a stake or stakes position(s) the body of the decoy as if it were standing, a posture that is common to feeding land birds. However, this has the disadvantage of requiring the hunter to move to the area where the animals are expected to congregate and spend some time setting up the decoys, thus likely providing some evidence of his prior presence.

Still other decoys have been developed with a weighted base and single support rod extending upwardly therefrom to support the decoy body. In the case of inflatable decoys, the hunter must spend the time to blow up the decoy, generally by mouth when in the field. Other decoys have molded shells, which means that they cannot be compressed for compact storage. None of these decoys can be quickly and easily deployed when a hunter using a game call hears an answering call, and knows he must deploy his decoys quickly. This is particularly true of turkey hunting, but is often true in other types of hunting as well.

Thus, a decoy structure solving the aforementioned problems is desired.

### SUMMARY OF THE INVENTION

The decoy structure has an upper central spine with a series of curved ribs extending laterally therefrom. The structure is open at the bottom, i.e., the ends of the left and right side ribs do not connect to one another across the lower portion of the structure. A support rod is resiliently attached to the approximate midpoint of the spine, and extends downwardly through the open bottom to a portable weighted base (sandbag, rigid base having a compound convex bottom curvature, etc.) when the decoy is deployed. A fabric cover having a pattern representing the object animal is removably attached to the ribs of the structure, e.g., by internal sleeves or pockets sewn into the cover, mating hook and loop fasteners, light adhesive, etc. Additional laterally disposed stringers may be included with the structure, if so desired. The spine, ribs, and lateral stringers may be formed of stiff but resilient wire having a springback property to return to the desired body shape after being released from compression. Alternatively, certain stiff but resilient plastics (e.g., nylon, etc.) may be used in lieu of metal wire. The resilience of the ribs allows them to have relatively rigid attachments to the spine. Alternatively, a flexible attachment such as a spring or the like, may be used to attach each rib to the spine.

The decoy may be compressed by squeezing the ribs to curl toward one another, thus reducing the diameter of the structure and allowing it to be inserted in a storage tube. The support rod and its weighted base are swung rearwardly through the open bottom side of the frame due to the spring attachment of the upper end of the support rod to the spine. When the decoy is to be deployed, the hunter need only withdraw it from its storage tube and toss it into the desired area. The resilient frame will promptly spring to its full size, expanding the cover to resemble a real animal. The spring attachment of the support rod to the spine causes the support rod to extend beneath the decoy frame. The weighted base carries the decoy structure to the general intended landing spot, with the relative mass of the base traveling downwardly ahead of and beneath the drag of the lightweight frame and cover as the decoy nears the surface. The result is that the decoy ends up in an upright posture with the weighted base supporting the decoy thereabove.

These and other features of the present invention will become readily apparent upon further review of the following specification and drawings.

### BRIEF DESCRIPTION OF THE DRAWINGS

FIG. 1 is a left side perspective view of a turkey decoy incorporating the decoy structure according to the present invention.

FIG. 2 is a front and left side perspective of a decoy structure according to the present invention, the cover being removed to show the internal components.

FIG. 3 is a partial perspective view of the interior of the decoy structure, showing a series of sleeves or pockets for attaching the cover to the frame.

FIG. 4 is a partial perspective view of the interior of the decoy structure, showing a series of hook and loop fasteners for attaching the cover to the frame.

FIG. 5 is a mid-section front elevation view of the frame of the decoy structure, showing the curling together of the ribs to reduce the outer diameter for compact storage.

FIG. 6 is a perspective view showing the compressed decoy structure being inserted into a small diameter storage tube.

FIG. 7 is an exploded perspective detail view of a portion of an alternative embodiment of a spine and rib assembly for a decoy structure according to the present invention, wherein the ribs are attached to the spine with springs.

Similar reference characters denote corresponding features consistently throughout the attached drawings.

### DETAILED DESCRIPTION OF THE PREFERRED EMBODIMENTS

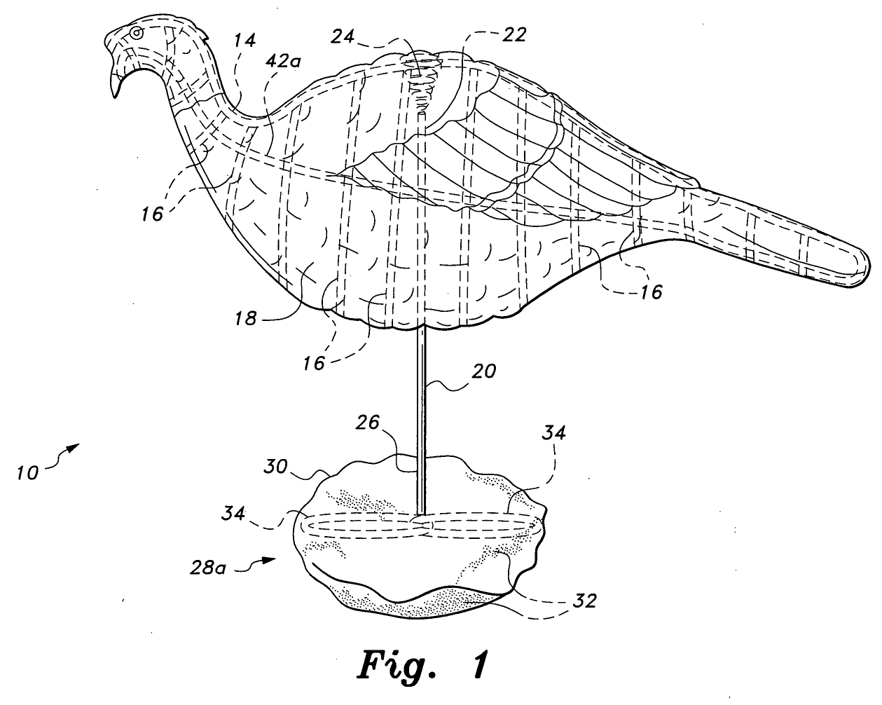

The present invention relates to various embodiments of a decoy structure that is configured to provide a lightweight and easily portable device that can be quickly deployed in the field with minimal preparation and effort. FIG. 1 of the drawings provides a left side perspective view of an exemplary decoy structure according to the present invention, comprising a turkey decoy 10. It will be understood that innumerable other representations of game animals may be formed using the general structural elements of the present decoy structure. The turkey decoy 10 is but one example of such a structure.

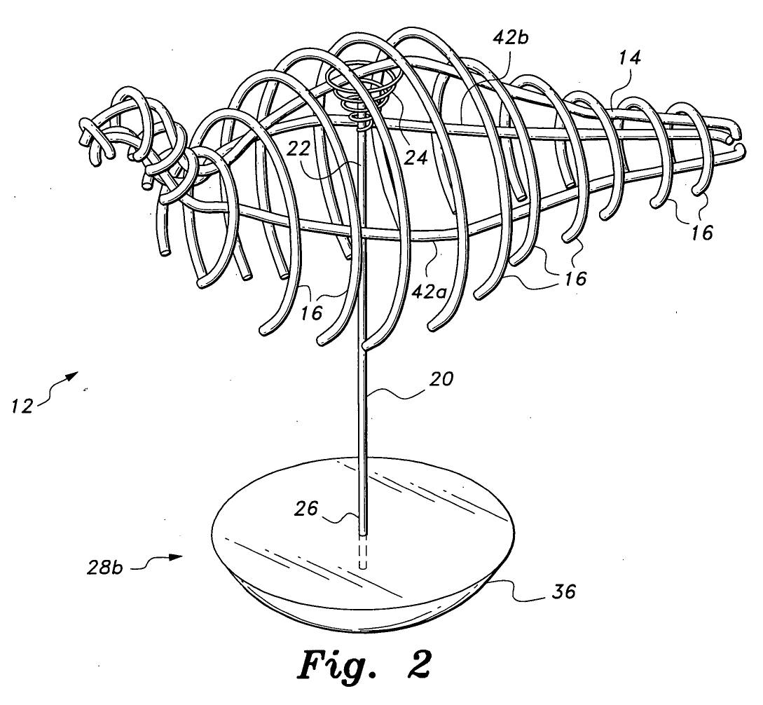

The turkey decoy 10 has a frame 12 (best shown in FIG. 2) formed of a plurality of thin, flexible, elongate elements comprising an elongate spine 14 having permanently attached (e.g., welded, bonded, etc.) ribs 16 substantially normal thereto. (The thicknesses of these elements may be exaggerated in the drawings for clarity.) The ribs 16 extend laterally to each side of the spine 14 and curve downwardly and continue to curve inwardly with their distal tips facing one another, in the manner of the anatomical rib cage of most vertebrate animals. The facing distal ends of each of the corresponding ribs 16 are spaced apart from one another, defining an open bottom area 18 for the decoy, as shown by the frame structure 12 illustrated in FIG. 2. These spine and rib elements 14 and 16 may be formed of metal wire, e.g., tungsten or spring steel. These materials provide excellent springback when bent or deflected short of their elastic limits. Alternatively, certain plastics (e.g., nylon) may have similar properties and may be used in lieu of metal.

A thin, flexible cover 18 (e.g., nylon or other fabric material) is removably secured over the frame 12, generally as shown in FIG. 1. The cover 18 includes a print or pattern to resemble the desired game animal, or other pattern or configuration in accordance with the configuration of the structure and the representation desired. Obviously, the shape of the cover 18 will be adjusted as necessary, in accordance with the structure 12 to which the cover is to be applied. The cover 18 is also open along its lower portion, and preferably extends to about the same point on each side as the distal ends of the ribs 16, or slightly beyond.

A single support rod 20 supports the frame 12 and overlying cover 18. The support rod 20 also comprises a thin, elongate, flexible length of material (tungsten, spring steel, certain plastics, etc.), as in the spine 14 and rib 16 components described further above. The upper end 22 of the support rod is resiliently attached to the approximate midpoint of the spine 14 by a spring 24. The spring may have a conical configuration, as shown in the drawings, with the small end of the cone attached to the upper end 22 of the support rod 20 and the larger diameter end screwed or threaded onto the general midpoint of the spine 14. Other spring configurations may be used. This resilient attachment of the support rod 20 to the spine 14 allows the support rod to swing rearwardly and upwardly through the open bottom portion of the frame 12 for compact storage of the decoy structure 10.

The opposite bottom end 26 of the support rod 20 is permanently installed in a weighted base, e.g., the “sandbag” or “beanbag” type base 28a, as shown in FIG. 1, or alternatively the solid base 28b shown in FIG. 2. The weighted base 28a of FIG. 1 has a flaccid cover 30 formed of a flexible sheet material (fabric, vinyl, etc.), loosely filled with innumerable small particles 32 (e.g., sand, gravel, etc.), in the manner of the conventional “sandbag” or “beanbag.” However, the lower end 26 of the support rod 20 includes a series of lateral stabilizer wires or elements 34 extending outwardly therefrom, as shown in FIG. 1. In the example of FIG. 1, these elements comprise a pair of wide loops, foreshortened in the left side perspective view of FIG. 1. The loop configuration precludes the relatively sharp end of a single wire element poking through the shell or cover 30 of the base 28a. Other stabilizer configurations may be provided as desired. The stabilizer wires or elements 34 tend to spread horizontally when the base contacts the surface after being tossed or dropped, thereby assuring that the support rod 20 will be oriented generally vertically.

Alternatively, the base may be formed as a solid and rigid unit, as in the weighted base 28b of FIG. 2. The base 28b includes a lower portion 36 having a compound convex curvature (e.g., hemispherical, parabolic, etc.) and a flat top, with the body of the base 28b formed as a solid mass of reasonably heavy material (e.g., dense plastic, aluminum, or perhaps iron or steel). Alternatively, the base 28b may be formed of a relatively lightweight wood, plastic, or the like, with a core of heavy material (lead, etc.) into which the lower end 26 of the support rod 20 is installed. The convex curvature of the weighted base assures that the base 28b will tend to rock itself upright as the center of gravity of the base 28b seeks its lowest level upon impact with the surface, thereby orienting the support rod 20 generally vertically.

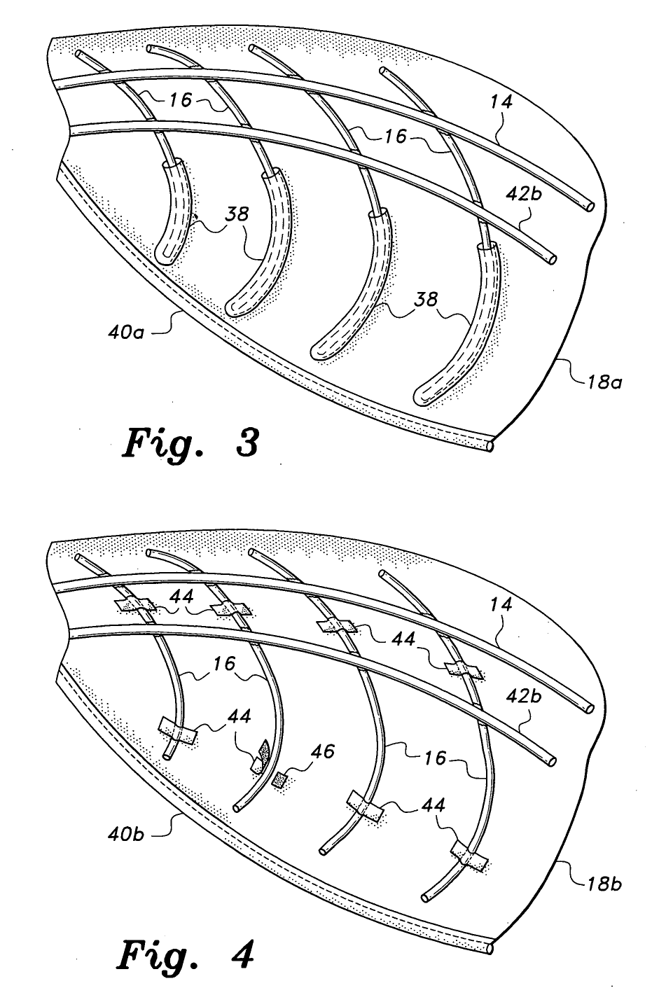

The cover 18 (or other variants thereof) is removably secured to the frame 12 using any of a number of various means. FIG. 3 illustrates one such cover attachment system, in which the cover 18a includes a series of long, narrow rib pockets or sleeves 38 attached (sewn, etc.) to the inner surface of the cover. The pockets or sleeves 38 correspond in number to the number of ribs 16 of the structure and extend from near the lower or bottom edge 40a of the cover 18a, i.e., to accept the distal ends of the ribs 16, and extend upwardly and outwardly some distance along the inner surface of the cover.

The sleeves or pockets 38 may be formed similarly to the sleeves sewn into the headliner of an automobile, through which a series of wire bows pass to hold the headliner in place. However, the pockets or sleeves 38 are not continuous across the entire width of the cover 18a, as the cover cannot be installed in a continuous lateral installation from one side to the other due to the intervening spine 14, and optional secondary stringers 42a, 42b that may be installed, if so desired, to provide additional rigidity for the deployed structure. Portions of the right side stringer 42b are shown in FIGS. 3 and 4, with the complete stringers being shown in FIGS. 1 and 2. These stringers 42a, 42b are installed generally parallel to the spine 14 and serve to hold the ribs 16 normal to the spine.

FIG. 4 illustrates another alternative cover attachment system, in which the cover 18b is removably secured over the underlying frame 12 by a series of hook and loop fasteners 44. One end of each of the fasteners 44 may be permanently secured (sewn, etc.) to the cover 18b, with the fasteners extending across the corresponding ribs and the opposite end removably attaching to a mating patch or spot of hook and loop material 46 sewn or otherwise permanently attached to the inner surface of the cover 18b. Other attachment means may be used, e.g., a light adhesive, such as rubber cement, to allow the cover 18b to be removed as necessary for cleaning, repair or replacement, etc.

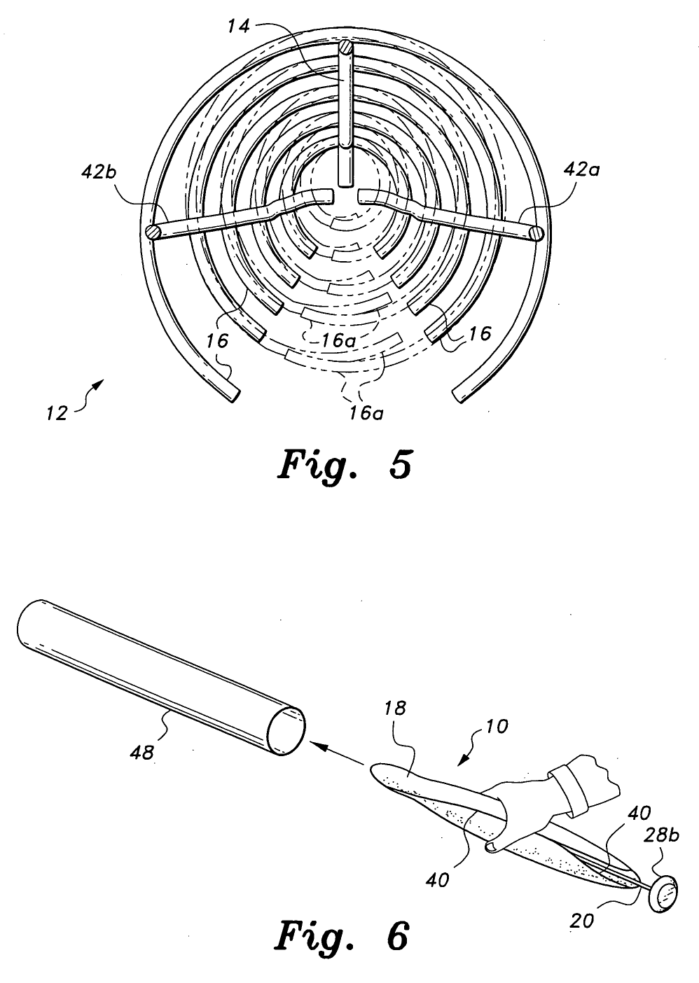

The decoy structure 10, including its cover installed therein, may be compressed significantly to allow it to be stored in a relatively small diameter tube or the like. FIGS. 4 and 5 illustrate this storage procedure. In FIG. 5, all of the ribs 16 are shown in their expanded state, i.e., as they would appear when the decoy structure is deployed, in solid lines. The cover 18 and support rod 20 are not shown in FIG. 5, for clarity in the drawing Fig. As the ribs 16 are formed of resilient material, they may be compressed inwardly and curled toward one another to reduce the diameter of the structure for storage. In FIG. 5, the ribs 16 are shown in a somewhat compressed configuration as ribs 16a in broken lines, with the diameter of the structure being reduced accordingly. It will be seen that the diameter may be reduced further, depending upon the flexibility and resilience of the ribs 16 and the amount of pressure applied to coil or curve the ribs toward one another.

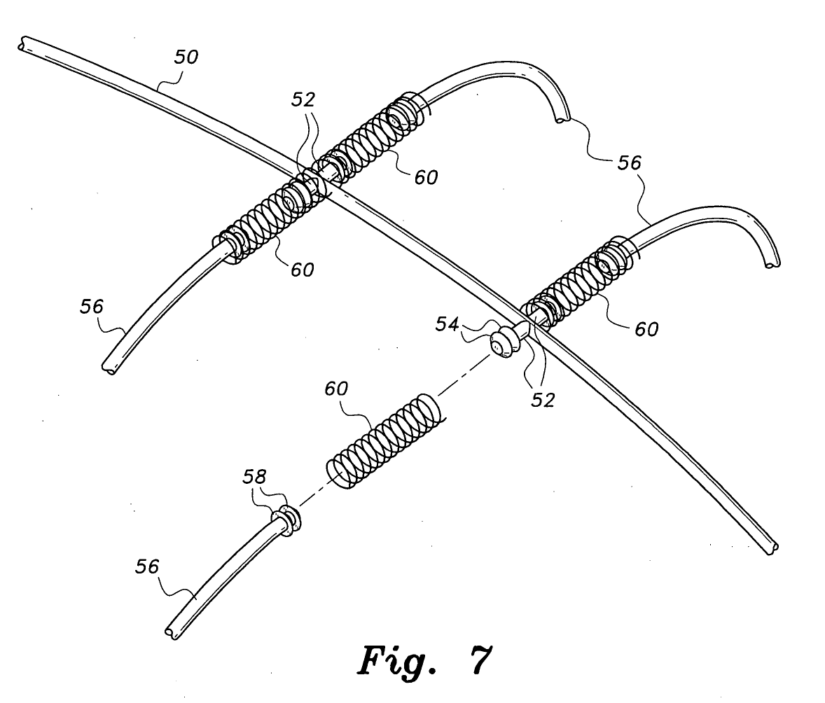

Once the diameter of the decoy structure 10 has been reduced as described above, the structure is of sufficiently small diameter to fit into a relatively small diameter storage tube 48, generally as shown in FIG. 6. It will be seen in FIG. 6 that one of the lower or outer edges 40 of the cover 18 overlaps the other, as the corresponding ribs have been curved inwardly to overlap one another as shown in FIG. 5. The compacted or collapsed decoy 10 with its smaller external diameter may then be inserted into the storage tube 48 for transport or storage. The support rod 20 has been folded rearwardly to align generally with the remainder of the structure, thus positioning the weighted base 28a or 28b rearwardly of the balance of the structure. The weighted base, either the flaccid base 28a or rigid base 28b, may serve as the closure for the tube 48, or a separate cap (not shown) may be provided.

FIG. 7 is an illustration of a portion of an alternative spine and rib assembly, wherein each of the ribs is resiliently secured to the spine by a coil spring. The spine 50 includes a series of short stubs or spurs 52 extending laterally therefrom with each of the stubs 52 having spring retention means thereon, e.g., generally conical spring retainers 54 or barbs or other structure that may be gripped by one end of the spring. Each of the ribs 56 includes corresponding spring retention means 58, e.g., conical retainers, barbs, or the like, extending from the spine attachment end thereof. A coil spring 60 is threaded onto or forced over the spring retainer(s) 54 of each of the stubs or spurs 52, and the spring retainers 58 of the ribs 56 are threaded or forced into the opposite ends of the coil springs 60 to secure the ribs 56 resiliently to the spine 50. This resilient attachment of spines to rib by means of the springs 60 allows the spines to be formed of a somewhat stiffer material than used in other embodiments, if so desired.

When the hunter has reached the desired hunting site, he or she may conceal himself or herself in a blind or other suitable structure as desired and use a game call or other means to attract game. When the hunter senses that the game has responded to the call, the decoys 10 of the present invention may be quickly and easily deployed by removing them from their storage tubes 48 and tossing them into the desired area. The decoys expand rapidly due to the resilient nature of their frames, with the ribs 16 (or 56, in the embodiment of FIG. 7) expanding to fill out the overlying cover 18. The support rod 20 extends downwardly beneath the frame, generally normal to the spine 14, due to the resilient attachment of the rod to the spine. The weight of the weighted base 28a or 28b tends to carry in front of the body portion of the decoy as it is tossed through the air due to the aerodynamic drag and light weight of the body portion with its cover, thus causing the base 28a or 28b to impact first and assuring that the decoy will alight and remain in an upright position. The light weight of the frame 12, the surface area of the cover 18, and the resilience of the structure, particularly the support rod 20, allow the decoy to rock slightly in the wind to mimic natural movement of the game animal. The solid base with its compound convex lower surface provides additional mobility for the decoy. When the hunter decides to move to a different site or terminate hunting for the day, the decoy 10 is easily rolled or curled to fit into the storage tube 48 for transport and storage, as described further above.

It is to be understood that the present invention is not limited to the embodiments described above, but encompasses any and all embodiments within the scope of the following claims.

I claim:

1. A decoy structure, comprising:
a thin, flexible, elongate spine;
a plurality of thin, flexible ribs extending and curving laterally and downwardly from the spine, the ribs having distal ends defining an open bottom;
a thin, flexible cover removably secured over the spine and ribs, the cover further having a pattern resembling a game animal;
a support rod having an upper end resiliently secured to a central area of the spine, the support rod having a lower end; and
a weighted base permanently attached to the lower end of the support rod.

2. The decoy structure according to claim 1, wherein the weighted base comprises a flaccid cover containing aggregate particles loosely disposed therein.

3. The decoy structure according to claim 1, wherein the weighted base comprises a solid form having a lower portion, the lower portion having a compound convex curvature.

4. The decoy structure according to claim 1, wherein the cover further includes a plurality of long, narrow rib pockets disposed therein, the pockets corresponding in number to the ribs, the pockets being removably installed over the ribs to secure the cover thereto.

5. The decoy structure according to claim 1, wherein the cover further includes a plurality of hook and loop fabric attachment tabs disposed therein, the tabs being removably attached to the ribs.

6. The decoy structure according to claim 1, further including laterally disposed left and right side secondary stringers, generally parallel to the spine.

7. The decoy structure according to claim 1, further including a storage tube, the spine, the ribs, the cover, the support rod, and the weighted base being removably placed in the tube for storage and transport.

8. A decoy structure, comprising:
a frame formed of a plurality of interconnected thin, flexible elements;
a cover removably disposed over the frame, the cover having a pattern resembling a game animal;
a support rod having an upper end secured to the frame, and a lower end; and
a weighted base permanently attached to the lower end of the support rod, the weighted base further having a flaccid cover containing aggregate particles therein.

9. The decoy structure according to claim 8, wherein the frame further comprises:
a thin, flexible, elongate spine; and
a plurality of thin, flexible ribs extending and curving laterally and downwardly from the spine, the ribs having distal ends defining an open bottom.

10. The decoy structure according to claim 9, wherein the cover further includes a plurality of long, narrow rib pockets disposed therein, the pockets corresponding in number to the ribs, the pockets being removably installed over the ribs to secure the cover thereto.

11. The decoy structure according to claim 9, wherein the cover further includes a plurality of hook and loop fabric attachment tabs disposed therein, the tabs being removably attached to the ribs.

12. The decoy structure according to claim 9, further including laterally disposed left and right side secondary stringers generally parallel to the spine.

13. The decoy structure according to claim 8, further including a storage tube, the frame, the cover, the support rod, and the weighted base being removably placed in the tube for storage and transport.

14. A decoy structure, comprising:
a thin, flexible, elongate spine;
a plurality of thin, flexible ribs extending from the spine;
a thin, flexible cover having a plurality of long, narrow rib pockets disposed therein, the pockets corresponding in number to the ribs, the pockets being removably installed over the ribs to secure the cover thereto, the cover having a pattern resembling a game animal;
a support rod having an upper end resiliently secured to a central area of the spine, and the support rod having a lower end; and
a weighted base permanently attached to the lower end of the support rod.

15. The decoy structure according to claim 14, wherein the weighted base comprises a flaccid cover containing aggregate particles loosely disposed therein.

16. The decoy structure according to claim 14, wherein the weighted base comprises a solid form having a lower portion, the lower portion having with a compound convex curvature.

17. The decoy structure according to claim 14, further including laterally disposed left and right side secondary stringers, generally parallel to the spine.

18. The decoy structure according to claim 14, further including a storage tube, the spine, the ribs, the cover, the support rod, and the weighted base being removably placed in the tube for storage and transport.
